(19) United States
(12) Patent Application Publication
(10) Pub. No.: US 2010/0103237 A1
(43) Pub. Date: Apr. 29, 2010

(54) RECORDING APPARATUS AND METHOD FOR DRYING TARGET

(75) Inventors: Keiji HARA, Minowa-machi (JP); Osamu SHINKAWA, Chino-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/605,445

(22) Filed: Oct. 26, 2009

(30) Foreign Application Priority Data
Oct. 27, 2008 (JP) 2008-275833

(51) Int. Cl. B41J 2/01; F26B 19/00

(52) U.S. Cl. 347/102; 34/282

(57) ABSTRACT

A recording apparatus includes a transport unit that transports a target from an upstream side of a transport direction to a downstream side of the transport direction, a recording unit having a configuration in which at least one of a plurality of unit heads is deviated from another unit head in the transport direction, and performing a recording operation by attaching liquid to a target by each unit head, the unit heads allowing liquid ejecting nozzles to form nozzle arrays in a width direction of the target perpendicular to the transport direction, and a plurality of drying units having an arrangement identical to the arrangement of the unit heads in the transport direction and the width direction at a downstream side of the transport direction as compared with the recording unit, and drying the target.

### BACKGROUND

1. Technical Field

The present invention relates to a recording apparatus for fixing recording to a target by promoting the drying of liquid attached to the target for which the recording has been performed, and a method for drying the target.

2. Related Art

According to the related art, an ink jet printer (hereinafter, referred to as a printer) is generally known as a recording apparatus that performs a recording operation by ejecting liquid to a target. According to the printer, ink (liquid) supplied to a recording head is ejected from nozzles formed in the recording head so that printing (recording) is performed with respect to a sheet serving as a target, and then the ink is forcibly dried by a drying apparatus.

Recently, as disclosed in patent document 1 (see JP-A-11-020175), such a printer includes a recording head in which a plurality of unit heads are arranged in a zigzag manner in a direction (i.e., width direction of a sheet) which is perpendicular to a transport direction of the sheet. In detail, according to the recording head of the printer, nozzle arrays extending in the width direction of the sheet in each unit head are deviated from other nozzle arrays of each unit head in the transport direction of the sheet, which are adjacent to the nozzle arrays in the width direction of the sheet. Thus, when printing is performed on the sheet being transported, ink is ejected at different ink ejection times toward the sheet from the nozzle arrays in the unit heads which are adjacent to each other in the width direction of the sheet.

However, after the ink is attached to the sheet, the ink spreads on the surface of the sheet and simultaneously penetrates into the sheet, so solvent components are evaporated, so that pigment components (solute) remaining on the sheet may produce a color. That is, if time difference occurs between the attachment of the ink and the drying of the ink, the color formation of the ink may be changed, so that the recording quality may be degraded.

### SUMMARY

An advantage of some aspects of the invention is that it provides a recording apparatus capable of improving the recording quality by allowing the time from the attachment of liquid to a target to the drying of the liquid to be uniform, and a method for drying the target.

According to a first aspect of the invention, there is provided a recording apparatus including a transport unit that transports a target from an upstream side of a transport direction to a downstream side of the transport direction, a recording unit having a configuration in which at least one of a plurality of unit heads is deviated from another unit head in the transport direction, and performing a recording operation by attaching liquid to a target by each unit head, the unit heads allowing liquid ejecting nozzles to form nozzle arrays in a width direction of the target perpendicular to the transport direction, and a plurality of drying units having an arrangement identical to the arrangement of the unit heads in the transport direction and the width direction at a downstream side of the transport direction as compared with the recording unit, and drying the target.

According to the above configuration, the unit heads including the nozzle arrays extending in the width direction while being deviated from each other in the transport direction are each located at the upstream side and the downstream side of the transport direction, and start to eject the liquid toward the target being transported at timings corresponding to the unit heads. Thus, the target may be divided into areas (hereinafter, referred to as primary attachment areas), to which the liquid is primarily attached through the unit heads located at the upstream side, and areas (hereinafter, referred to as secondary attachment areas), to which the liquid is attached through the unit heads located at the downstream side at a timing different from a timing at which the liquid is ejected toward the primary attachment areas. The drying units are deviated from each other in the transport direction of the target such that the drying units have an arrangement identical to the arrangement of the unit heads. Thus, the primary attachment areas are primarily subject to a drying process by the drying units facing the primary attachment areas as compared with the secondary attachment areas. Therefore, the difference between the time until the drying process is performed with respect to the primary attachment areas after the attachment of the ink and the time until the drying process is performed with respect to the secondary attachment areas after the attachment of the ink can be reduced, so that the same drying process is performed with respect to the primary attachment areas and the secondary attachment areas. Consequently, the difference of the image quality in each area on the target can be reduced, so that the recording quality of the target can be improved.

According to the recording apparatus of the invention, each drying unit has a widthwise size, which is identical to a widthwise size of the nozzle arrays formed in each unit head. The widthwise sizes of the primary attachment area and the secondary attachment area coincide with the widthwise size of the nozzle arrays formed in each unit head. According to the above configuration, the width of the drying unit coincides with the widthwise size of the nozzle array, so that the dryable widths of the drying unit coincide with the primary attachment area and the secondary attachment area, respectively. Thus, the width of the nozzles array is employed as a reference, so that the drying unit corresponding to the primary attachment area and the secondary attachment area can be provided in a simple manner.

According to the recording apparatus of the invention, the drying unit is provided with a blowing passage formation member which has a blowing path extending in the transport direction and is formed with a blowing port that extends in the transport direction to blow air toward the target in the blowing path while facing the target, the blowing path having a sectional area in the upstream side of the transport direction, which is larger than a sectional area in the downstream side of the transport direction.

The drying speed of the liquid is increased proportionally to the speed of the air flowing along the surface of the liquid. Further, the speed of the air flowing in the blowing passage becomes faster as the sectional area of the blowing passage is reduced. According to the above configuration, since the sectional area of the blowing passage is large at the upstream side and small at the downstream side, the speed of the air passing through the blowing passage becomes slower at the upstream side and becomes faster at the downstream side. Thus, the target printed with the liquid and transported with high fluidity is dried to a certain degree by the air with a low speed at the upstream side, so that the fluidity of the liquid is degraded. Then, the liquid having the degraded fluidity is shifted to the downstream side and drying of the liquid is prompted by the air with a high speed. Thus, the liquid can be efficiently evaporated without changing the print quality of the target.

According to the recording apparatus of the invention, the drying unit is provided with a blowing passage formation member and a sectional area change unit, the blowing passage formation member having a blowing path extending in the transport direction and being formed with a blowing port that extends in the transport direction to blow air toward the target in the blowing path while facing the target, the blowing path having a sectional area in the upstream side of the transport direction, which is larger than a sectional area in the downstream side of the transport direction, the sectional area change unit changing a sectional area of the blowing path in the blowing passage formation member by moving a wall surface of the blowing path.

According to the above configuration, the sectional area of the blowing passage varies depending on the type of the target and attachment of the liquid, so the speed of the air passing through the blowing passage is changed, so that the drying speed of the liquid can be changed corresponding to print conditions. For example, in a case in which the transport speed is increased in special consideration of the recording speed, the section area of the blowing passage is reduced, so the speed of the air and the drying speed of the liquid are increased, so that recording can be fixed to the target while the target is passing through the drying unit.

According to a second aspect of the invention, there is provided a method for drying a target including performing a first recording process of attaching liquid to a target at a first timing, performing a second recording process of attaching the liquid to a position of the target, which is different from a liquid attachment position in the first recording process, at a second timing different from the first timing, performing a first drying process of drying the liquid attached to the target in the first recording process, and performing a second drying process of drying the liquid, which is attached to the target in the second recording process, with a time difference between the first timing and the second timing.

According to the above configuration, the liquid, which is primarily attached to the target in the first recording process as compared with the second recording process, is dried in the first drying process. That is, since the liquid is subject to the drying process according to the attachment sequence to the target, the same drying process is performed with respect to the liquid primarily attached and the liquid secondarily attached, so that the recording quality of the target can be improved.

### BRIEF DESCRIPTION OF THE DRAWINGS

The invention will be described with reference to the accompanying drawings, wherein like numbers reference like elements.

FIG. 1 is a front view schematically showing a printer according to a first embodiment.

FIG. 2 is a plan view schematically showing a printer.

FIG. 3 is a bottom view schematically showing a recording head.

FIG. 4 is a sectional view schematically showing a drying unit.

FIG. 5 is a sectional view schematically showing a first drying unit according to a second embodiment.

FIG. 6 is a sectional view schematically showing a first drying unit according to a third embodiment.

FIG. 7 is a sectional view schematically showing a first drying unit.

### DESCRIPTION OF EXEMPLARY EMBODIMENTS

### First Embodiment

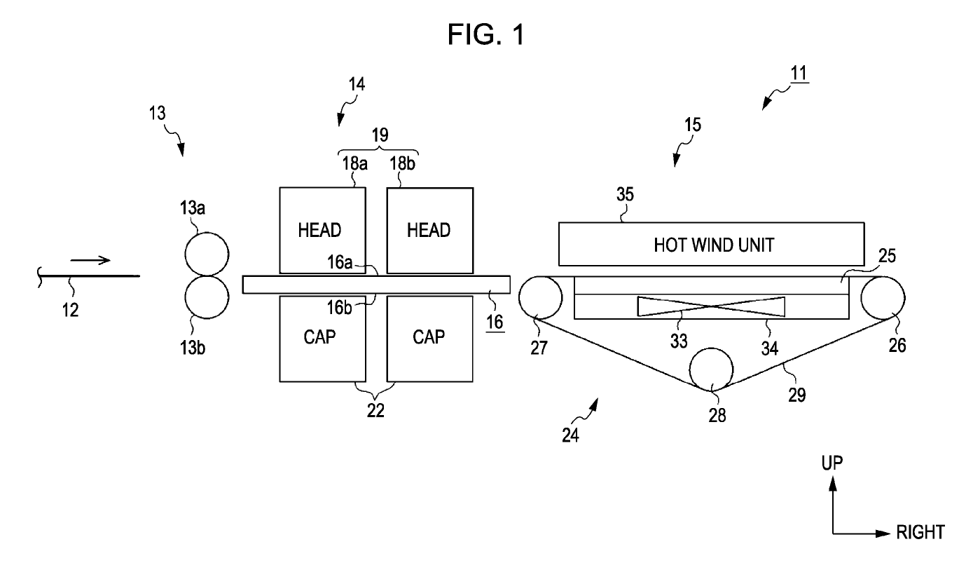

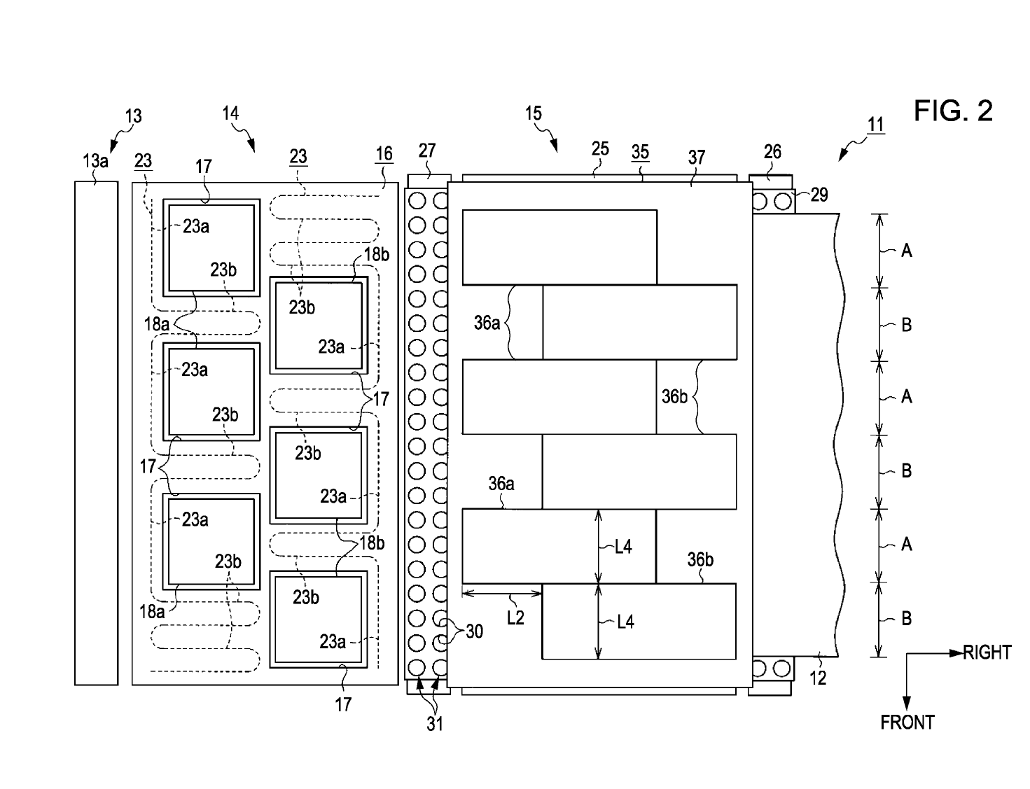

Hereinafter, a recording apparatus embodied as an ink jet printer (hereinafter, referred to as a printer) according to a first embodiment of the invention will be described with reference to FIGS. 1 to 4. In the following description, front and rear directions, right and left directions, and up and down directions refer to directions indicated by arrows shown in FIGS. 1 and 2.

As shown in FIGS. 1 and 2, the printer 11 serving as the recording apparatus includes a preheat device 13 that heats a sheet 12 which is supplied from a sheet feeding tray (not shown) as a target, a printing unit 14 that performs printing with respect to the sheet 12 heated by the preheat device 13, and a drying device 15 that dries the sheet 12 so that printing is fixed. The sheet 12 dried by the drying device 15 is discharged to a sheet discharge tray (not shown).

The preheat device 13 includes a pair of upper and lower heat rollers 13a and 13b, which make contact with both surfaces of the sheet 12 which is not printed, to nip the sheet 12 and send the sheet 12 to the printing unit 14 one by one. Further, the heat rollers 13a and 13b are heated by a heater (not shown). That is, the sheet 12 is heated by heat from the heat rollers 13a and 13b when the sheet 12 is nipped by the heat rollers 13a and 13b.

Next, the printing unit 14 will be described.

The printing unit 14 includes a platen 16 having a rectangular shape, and an upper surface 16a of the platen 16 serves as a transport path of the sheet 12. Further, the platen 16 is formed with a plurality of rectangular through holes 17 (six through holes in the embodiment) which are formed through the upper surface 16a and the lower surface 16b of the platen 16 in a zigzag manner in the width direction (front and rear directions) of the sheet 12, which are perpendicular to the transport direction (right and left directions) of the sheet 12.

Further, a recording head 19 serving as a recording unit is installed above the platen 16 in correspondence with the up and down directions of the through holes 17, and includes a plurality of first unit heads 18a (three unit heads in the embodiment) and a plurality of second unit heads 18b (three unit heads in the embodiment). In detail, as shown in FIG. 2, the first unit heads 18a, which are installed at an upstream side (left side) of the transport direction, and the second unit heads 18b, which are installed at a downstream side (right side) as compared with the first unit heads 18a, are arranged in a zigzag manner such that no gap is formed in the front and rear directions.

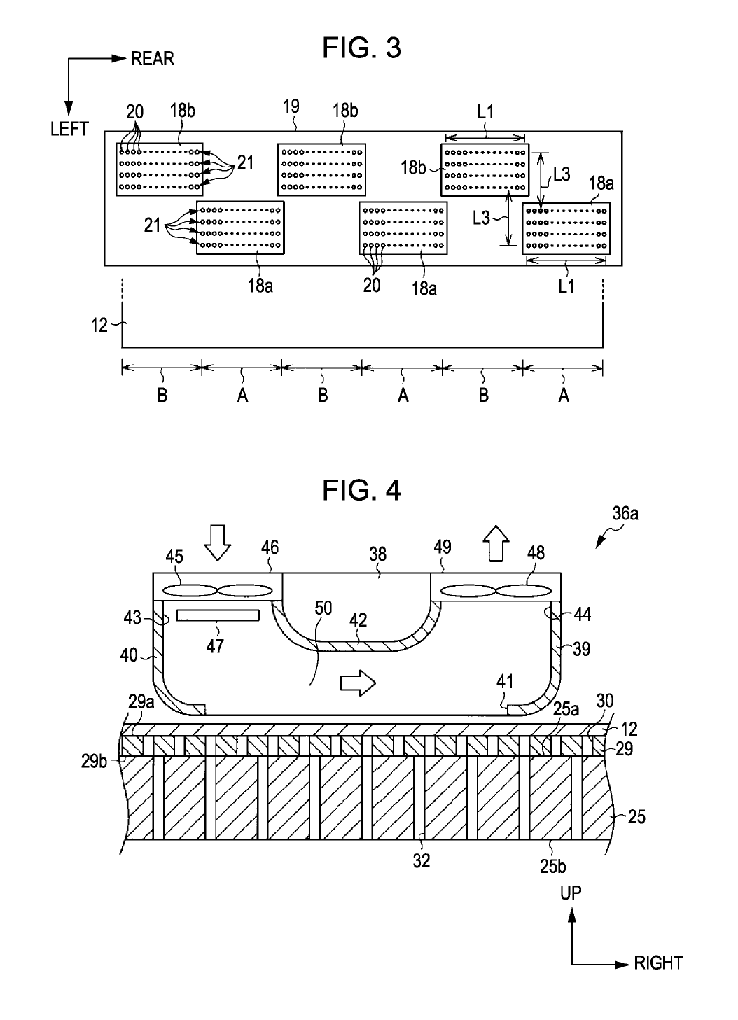

Further, as shown in FIG. 3, a plurality of nozzles 20 are formed on nozzle installation surfaces serving as the lower surfaces of the unit heads 18a and 18b to eject ink (liquid) toward the sheet 12 transported along the upper surface 16a of the platen 16. Further, the nozzles 20 form a plurality of nozzle arrays 21 (four arrays in the embodiment) in each of the unit heads 18a and 18b in the front and rear directions. Further, various types (colors) of inks are supplied to the nozzle arrays 21 in each of the unit heads 18a and 18b from an ink cartridge (not shown), and then are ejected toward the sheet 12 from the nozzles 20 of each nozzle array 21, so that printing is performed as a recording process.

Further, according to the embodiment, the configurations of the unit heads 18a and 18b are identical to each other, except for the arrangements of the unit heads 18a and 18b. Accordingly, widths L1 of the nozzle arrays 21 in the unit heads 18a are identical to widths L1 of the nozzle arrays 21 in the unit heads 18b in the front and rear directions. Thus, primary attachment areas A of the sheet 12, to which the ink is primarily ejected from the first unit heads 18a, and secondary attachment areas B of the sheet 12, to which the ink is ejected from the second unit heads 18b at a timing different from a timing at which the ink is ejected to the primary attachment areas A, are arranged in a band shape in the right and left directions such that the widths of the primary attachment areas A are identical to the widths of the secondary attachment areas B in the front and rear directions.

Meanwhile, caps 22 in the same quantity as the number of the through holes 17 are installed below the platen 16 in a zigzag manner in correspondence with the through holes 17 in the up and down directions. Each cap 22 is provided with a movable unit (not shown) that moves the cap 22 in the up and down directions. Thus, if the caps 22 move upward through the through holes 17 as the movable unit is driven, the caps 22 make contact with the nozzle arrays 21 with respect to the nozzle installation surfaces of the unit heads 18a and 18b, to which the through holes 17 correspond, while surrounding the nozzle arrays 21.

As shown in FIG. 2, a plurality of platen heaters 23 (two heaters in the embodiment) are installed in the platen 16. Each platen heater 23 generates heat using current applied from a heating unit (not shown) to heat the platen 16.

Further, the platen heaters 23 have the same shapes and are point symmetrically formed about the center of the platen 16. In detail, each platen heater 23 has a zigzag shape with a point-symmetric arrangement by bending one elongated member, which extends in the front and rear directions, many times such that the elongated member is prevented from making contact with the through holes 17. Further, each platen heater 23 includes a plurality of first heating units 23a (three heating units in the embodiment), which are disposed between both ends of the platen 16 in the right and left directions and the through holes 17, and a plurality of second heating units 23b (four heating units in the embodiment), which are each formed by bending the first heating units 23a in the right and left directions and are disposed between the through holes 17 and between the through holes 17 and both ends of the platen 16 in the front and rear directions.

Then, the drying device 15 will be described.

As shown in FIG. 1, the drying device 15 is provided with a transport unit 24 serving as a transport device to pull a front end of the sheet 12, which is carried from the preheat unit 13, in such a manner that the sheet 12 slidably moves along the upper surface 16a of the platen 16 in the printing unit 14.

The transport unit 24 includes a rectangular support plate 25 having a width wider than that of the sheet 12 (see FIG. 2). A driving roller 26 extending in the front and rear directions is provided at a right side of the support plate 25 and is rotated by a driving motor (not shown). Further, a driven roller 27 extending in the front and rear directions is provided at a left side of the support plate 25 and is rotated together with the driving roller 26. Further, a tension roller 28 extending in the front and rear directions is provided below the support plate 25 and is rotated together with the driving roller 26 and the driven roller 27.

One endless belt 29 is wound around the driving roller 26, the driven roller 27 and the tension roller 28 to surround the support plate 25. When the endless belt 29 slidably moves on the support plate 25, a surface 29a of the belt 29 (see FIG. 4) coincides with the upper surface 16a of the platen 16. Further, the tension roller 28 is urged downward by a spring member (not shown) so that tension is applied to the belt 29, thereby preventing the belt 29 from being loosened.

Further, the driving roller 26 is rotated clockwise by a driving motor (not shown) when viewed in a front view, so that the belt 29 is rotated (driven) clockwise along an outer side of the driving roller 26, the tension roller 28 and the driven roller 27 when viewed in a front view. In such a case, an inner surface of the belt 29 slidably moves along an upper surface 25a (see FIG. 4) of the support plate 25 from the left side to the right side, so that the sheet 12 on the belt 29 is transported from the left side (upstream side) to the right side (downstream side). Further, the belt 29 is rotated such that a transport speed of the sheet 12 by the belt 29 is identical to a transport speed of the sheet 12 by the heat rollers 13a and 13b.

As shown in FIG. 4, the belt 29 is formed with a plurality of air holes 30 which vertically extend through the surface 29a, which serves as a support surface to support the sheet 12, and a rear surface 29b that makes sliding-contact with the support plate 25. Further, the air holes 30 are regularly arranged such that a plurality of air hole arrays 31 (see FIG. 2) disposed in the front and rear directions are spaced apart from each other in the right and left direction by a predetermined interval.

Further, the support plate 25 is formed with a plurality of absorption holes 32 which vertically (extend through the support plate 25, that is, which are formed in the thickness direction of the support plate 25. An absorption unit 34 (see FIG. 1) having a casing shape and a fan 33 (see FIG. 1) therein is installed below the support plate 25 to cover openings of the absorption holes 32 formed through a lower surface 25b of the support plate 25. Further, as the fan 33 is driven, the absorption holes 32 are in a negative pressure state, so that absorption force is applied downward to the sheet 12 loaded on the belt 29 through the air holes 30 which communicate with the absorption holes 32.

Further, a hot wind unit 35 is installed above the transport unit 24 to promote the drying of the sheet 12 transported to the transport unit 24 after being printed by the printing unit 14. The hot wind unit 35 dries the ink by blowing hot wind toward the surface of the sheet 12 to which the ink is attached, so that printed content can be fixed to the sheet 12.

As shown in FIG. 2, the hot wind unit 35 includes first drying units 36a (three drying units in the embodiment) and second drying units 36b (three drying units in the embodiment) extending rightward beyond the first drying units 36a, which are arranged in a zigzag manner in the front and rear directions to serve as a plurality of rectangular drying devices that extend in the right and left directions when viewed in a plan view. The first drying units 36a and the second drying units 36b are fixed to a plate 37 having a rectangular shape in such a manner that the first drying units 36a correspond to the first unit heads 18a in the right and left directions and the second drying units 36b correspond to the second unit heads 18b in the right and left directions. That is, the number of the first unit heads 18a is identical to the number of the first drying units 36a, and the number of the second unit heads 18b is identical to the number of the second drying units 36b.

In addition, the distance L2 between one end of the first drying unit 36a and one end of the second drying unit 36b in the right and left directions is identical to the distance L3 (see FIG. 3) between the first nozzle array 21 formed in the first unit head 18a and the first nozzle array 21 formed in the second unit head 18b. In the same manner, the distance L2 is identical to the distance L3 between the fourth nozzle array 21 formed in the first unit head 18a and the fourth nozzle array 21 formed in the second unit head 18b. Further, widths L4 of the first and second drying units 36a and 36b are identical to widths L1 (see FIG. 1) of the nozzle arrays 21 formed in the first and second unit heads 18a and 18b which correspond to the first and second drying units 36a and 36b in the right and left directions, respectively.

That is, since the widths L1 of the nozzle arrays 21 formed in the first and second unit heads 18a and 18b are identical to each other, the same drying units are deviated from each other in the right and left directions and the front and rear directions according to the embodiment, and the drying units located at the upstream side (left side) of the transport direction are referred to as the first drying units 36a and the drying units located at the downstream side (right side) of the transport direction are referred to as the second drying units 36b. Since the first drying unit 36a has a configuration the same as the configuration of the second drying unit 36b, the first drying unit 36a will be described in detail as an example with reference to FIG. 4.

As shown in FIG. 4, the first drying unit 36a includes a pair of sidewalls 38 having a substantially rectangular shape while facing each other in the front and rear directions, a right wall 39 having a j section, and a left wall 40 which is plane-symmetrical to the right wall 39 about the center portion of the sidewalls 38 in the right and left directions. The right wall 39 and the left wall 40 are fixed to the sidewalls 38. According to the above configuration, a blowing port 41 having a rectangular shape, which is surrounded by the lower peripheries of the front and rear sidewalls 38, the right wall 39 and the left wall 40 while extending in the right and left directions, is formed on the lower surface of the first drying unit 36a.

An upper wall 42 having a strong U section is fixed between the front and rear sidewalls 38 above the blowing port 41 such that openings 43 and 44 are formed upward at right and left sides of the upper wall 42. The left opening 43 is provided with a blowing unit 46 having a casing shape and a blowing fan 45, which introduces external air into the first drying unit 36a, and a hot wind heater 47 that heats the air introduced by the blowing fan 45. Further, the right opening 44 is provided with an exhaust unit 49 having a casing shape and an exhaust fan 48 that exhausts the air in the first drying unit 36a to the outside.

According to the above configuration, as indicated by a white arrow in FIG. 4, the air (wind) flows downward in the vicinity of the blowing unit 46, and then flows upward in the vicinity of the exhaust unit 49. In detail, the exhaust unit 49 is installed to prevent the wind from blowing from the blowing port 41 to the outside, so that the air becomes hot wind and flows from the left side and the right side in the first drying unit 36a. Thus, the first drying unit 36a is formed with a blowing passage 50 that extends in the transport direction of the sheet 12 by the sidewalls 38, the right wall 39, the left wall 40 and the upper wall 42, which serve as a blowing passage formation member. Further, the sheet 12, which is transported by the transport unit 24 while facing the blowing port 41, is subject to drying by the hot wind which blows from the blowing port 41.

Hereinafter, the operation of the printer 11 having the configuration as described above will be described while focusing on the drying operation of the drying device 15, which is performed with respect to the sheet 12 after the printing has been completed.

When the printing is performed, the heater that heats the heat rollers 13a and 13b, the platen heater 23 and the hot wind heater 47 are heated through current applied thereto such that the heater, the platen heater 23 and the hot wind heater 47 reach the temperature suitable for the printing. At this time, the heat rollers 13a and 13b are rotated and simultaneously the driving roller 26 is rotated, so that the belt 29 is rotated.

If the sheet 12 is supplied from a sheet feeding tray (not shown), the sheet 12 is nipped by the heat rollers 13a and 13b being rotated and is sent to the printing unit 14. At this time, the sheet 12 is preheated (preliminary heating) by heat from the heat rollers 13a and 13b.

Further, the printing unit 14 ejects ink toward the sheet 12 slidably moving on the platen 16 after being carried from the preheat device 13. In detail, the ink is ejected to the primary attachment areas A of the sheet 12 when the sheet 12 passes through the first unit heads 18a (first timing) (first recording process). Then, the ink is ejected to the secondary attachment areas B of the sheet 12 when the sheet 12 passes through the second unit heads 18b (second timing) (second recording process).

Further, the transport unit 24 absorbs the sheet 12 carried from the preheat device 13 to transport the sheet 12. Thus, the entire area of the sheet 12 in the right and left directions is sequentially supported by the platen 16 and the ink is ejected toward the sheet 12 from the unit heads 18a and 18b. Then, if the sheet 12 is transported to the drying device 15, the primary attachment areas A are primarily dried by the first drying units 36a (first drying process). Then, as the sheet 12 is transported, the secondary attachment areas B are secondarily dried by the second drying units 36b located at the downstream side as compared with the first drying units 36a (second drying process).

Further, the transport speed of the sheet 12 by the heat rollers 13a and 13b is identical to the transport speed of the sheet 12 by the transport unit 24. In addition, the distance L3 between the first nozzle array 21 in the first unit head 18a and the first nozzle array 21 in the second unit head 18b is identical to the distance L2 of a left end of the blowing port 41 in the first drying unit 36a and the distance L2 of a left end of the blowing port 41 in the second drying unit 36b.

Thus, the difference between the drying time for the primary attachment areas A and the drying time for the secondary attachment areas B is identical to the difference between the ink ejection start time for the primary attachment areas A and the ink ejection start time for the secondary attachment areas B, that is, the time difference between the first timing and the second timing. Accordingly, the time until the drying process is performed with respect to all portions of the primary attachment areas A after the ink is attached to the primary attachment areas A is substantially identical to the time until the drying process is performed with respect to all portions of the secondary attachment areas B after the ink is attached to the secondary attachment areas B. Further, the drying device 15 fixes printing to the sheet 12 by promoting the drying of the ink attached to the sheet 12 after the printing has been performed by the printing unit 14, and discharges the sheet 12 to a sheet discharge tray (not shown).

According to the first embodiment, the following effects can be obtained.

(1) the unit heads 18a and 18b including the nozzle arrays 21 extending in the front and rear directions while being deviated from each other in the right and left directions are each located at the upstream side (left side) and the downstream side (right side) of the transport direction, and start to eject the ink toward the sheet 12 being transported at corresponding timings. Thus, the sheet 12 is divided into the primary attachment areas A and the secondary attachment areas B. Further, the plurality of the drying units 36a and 36b are deviated from each other in the right and left directions such that the drying units 36a and 36b have arrangements the same as the arrangements of the plurality of the unit heads 18a and 18b in the transport direction of the sheet 12. Accordingly, the primary attachment areas A are primarily dried by the first drying units 36a while facing the first drying units 36a, as compared with the secondary attachment areas B. Therefore, the difference between the time until the drying process is performed with respect to the primary attachment areas A after attachment of the ink and the time until the drying process is performed with respect to the secondary attachment areas B after attachment of the ink can be reduced, so that the same drying process is performed with respect to the primary attachment areas A and the secondary attachment areas B. Thus, the difference of the image quality in each area on the sheet 12 can be reduced, so that the recording quality of the sheet 12 can be improved.

(2) the widthwise sizes of the primary attachment area A and the secondary attachment area B coincide with the widths L1 of the nozzle arrays 21 in the unit heads 18a and 18b, and the widths L4 of the drying units 36a and 36b coincide with the widths L1 of the nozzle arrays 21, so that the dryable widths of the drying units 36a and 36b coincide with the primary attachment area A and the secondary attachment area B, respectively. Thus, the width L1 of the nozzles array 21 is employed as a reference, so that the hot wind unit 35 corresponding to the primary attachment area A and the secondary attachment area B can be provided in a simple manner.

(3) the ink primarily ejected to the sheet 12 from the first unit heads 18a as compared with the second unit heads 18b is dried by the first drying unit 36a. That is, since the ink is dried according to the attachment sequence, the same drying process is performed with respect to the ink primarily attached and the ink secondarily attached. Thus, the print quality of the sheet 12 can be improved.

### Second Embodiment

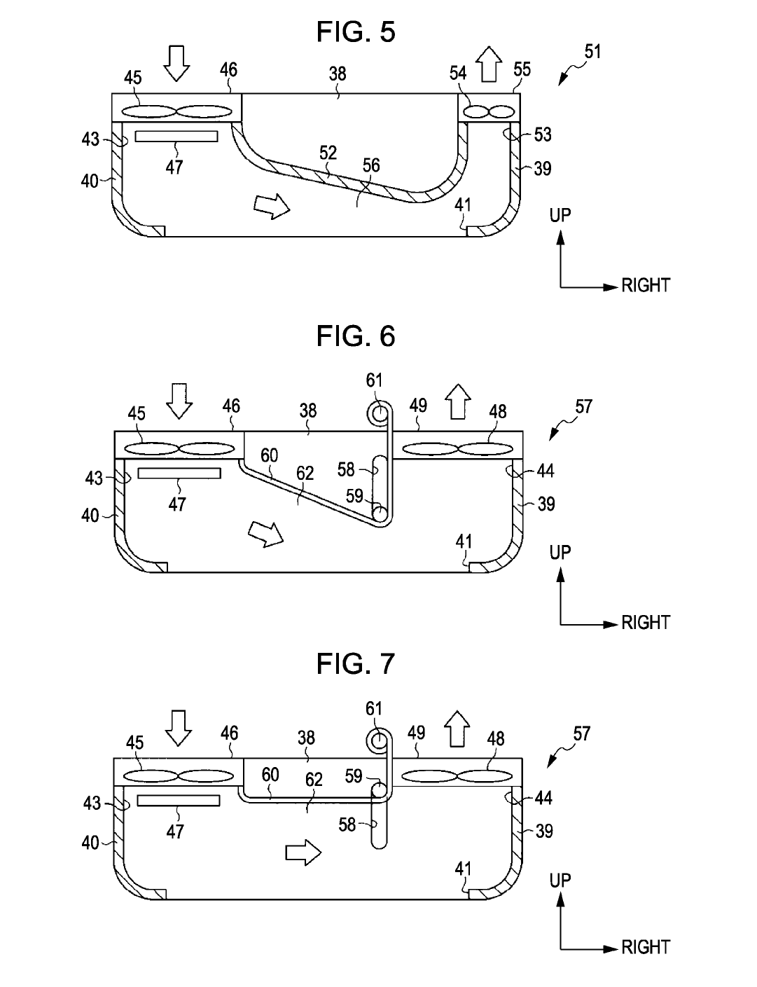

Hereinafter, the second embodiment of the invention will be described with reference to FIG. 5. Since the second embodiment is identical to the first embodiment except that the configuration of the first and second drying units is changed, the same reference numerals are used to designate the same elements and detailed description thereof will be omitted.

Further, since the first drying unit has a configuration the same as that of the second drying unit in the second embodiment similarly to the first embodiment, the first drying unit will be described in detail as an example with reference to FIG. 5.

As shown in FIG. 5, an upper wall 52 of the first drying unit 51 is inclined from the left side to the right side so that the upper wall 52 approaches the blowing port 41. Further, a right opening 53 formed by the upper wall 52, the right wall 39 and the sidewalls 38 is relatively smaller than the left opening 43 formed by the upper wall 52, the left wall 40 and the sidewalls 38. Thus, a discharge unit 55 having a casing shape with a discharge fan 54 is relatively smaller than the exhaust unit 49 of the first embodiment according to the size of the opening 53.

Further, a pair of the sidewalls 38 are configured to be parallel to each other, so that a blowing passage 56 of the first drying unit 51 has a sectional area which is gradually reduced from the left side to the right side (the downstream side of the transport direction).

In addition, since the speed (wind speed) of the air flowing in the blowing passage 56 is inversely proportional to the sectional area, the speed of the air becomes faster as the sectional area of the blowing passage 56 is reduced. Further, the drying speed of the ink becomes faster as the speed of the hot wind blowing toward the ink attachment surface becomes faster, but the fluidity of the ink on the surface of the sheet 12 is degraded as the ink is dried.

Thus, if the sheet 12 printed with the ink having high fluidity by the printing unit 14 is transported to the drying device 15, the sheet 12 is primarily dried to a certain degree by wind with low speed, so that the fluidity of the ink attached to the sheet 12 is reduced. Then, if the sheet 12 is transported by the transport unit 24, the speed of the hot wind blowing toward the sheet 12 gradually becomes faster, so that the drying speed of the ink gradually becomes faster.

According to the second embodiment, the following effects can be further obtained in addition to the above effects (1) to (3) according to the first embodiment.

(4) the drying speed of the ink is increased proportionally to the speed of the wind flowing along the surface of the ink. Further, the speed of the hot wind flowing in the blowing passage 56 becomes faster as the sectional area of the blowing passage 56 is reduced. According to the above configuration, since the sectional area of the blowing passage 56 is large at the left side and small at the right side, the speed of the hot wind passing through the blowing passage 56 becomes slower at the left side and becomes faster at the right side. Thus, the sheet 12 printed with the ink and transported with high fluidity is dried to a certain degree by the hot wind with a low speed at the left side, so that the fluidity of the ink is reduced. Then, the ink having the reduced fluidity is shifted to the right side and drying of the ink is prompted by the hot wind with a high speed. Thus, the ink can be efficiently evaporated without changing the print quality of the sheet 12.

### Third Embodiment

Hereinafter, the third embodiment of the invention will be described with reference to FIGS. 6 and 7. Since the third embodiment is identical to the first embodiment except that the sectional areas of the blowing passage of the first and second drying units are changed, the same reference numerals are used to designate the same elements and detailed description thereof will be omitted.

Further, since the first drying unit has a configuration the same as that of the second drying unit in the third embodiment similarly to the first and second embodiments, the first drying unit will be described in detail as an example with reference to FIG. 6.

As shown in FIG. 6, a pair of the front and rear sidewalls 38 of the first drying unit 57 are formed with long guide holes 58 which vertically extends therethrough while facing each other. Further, a rotary pressing roller 59 is installed in the guide holes 58 so that the pressing roller is guided through the guide holes 58 to move up and down.

Further, in the embodiment, the upper wall is prepared in the form of a flexible film 60 which is installed between the sidewalls 38 in the front and rear directions. That is, the left end of the film 60 adheres to the blowing unit 46. Further, the film 60 is wound around the lower side of the pressing roller 59 and the right end of the film 60 is wound around a winding roller 61 which is installed above the sidewalls 38 and extends in the front and rear directions. In addition, the winding roller 61 is supported by a bracket (not shown) and is rotated by a motor (not shown).

If the winding roller 61 is rotated counterclockwise in the state shown in FIG. 6, the film 60 is wound around the winding roller 61. Then, the pressing roller 59 is drawn by the film 60 and moves upward along the guide holes 58, so that the wall surface moves upward as shown in FIG. 7. Thus, a sectional area of a blowing passage 62 at the downstream side (right side) is increased, so that the wind speed is slightly changed in the blowing passage 62.

Meanwhile, if the winding roller 61 is rotated clockwise in the state shown in FIG. 7, the film 60 is loosened, so that the pressing roller 59 moves downward along the guide holes 58. That is, since the film 60 is pressed downward by the weight of the pressing roller 59, the sectional area of the blowing passage 62 at the downstream side (right side) is reduced as shown in FIG. 6, so that the wind speed is changed between the left side and the right side in the blowing passage 62.

Thus, the film 60, the pressing roller 59 and the winding roller 61 serve as a sectional area change unit.

According to the third embodiment, the following effects can be further obtained in addition to the above effects (1) to (4) according to the previous embodiments.

(5) the sectional area of the blowing passage 62 varies depending on the type of the sheet 12 and attachment of the ink, so the wind speed passing through the blowing passage 62 is changed, so that the drying speed of the ink can be changed corresponding to print conditions. For example, in a case in which the transport speed of the sheet 12 is increased by increasing the rotation speed of the belt 29 in special consideration of the print speed, the winding roller 61 is rotated clockwise such that the section area of the blowing passage 62 is reduced, so the wind speed in the blowing passage 62 and the drying speed of the ink attached to the sheet 12 are increased, so that printing can be fixed to the sheet 12 while the sheet 12 is passing through the hot wind unit 35.

In addition, the third embodiment may be modified as follows.

Differently from the third embodiment, a closing plate, which is formed at the upper end thereof with a hole for allowing the pressing roller 59 to rotate, may be installed at both ends of the pressing roller 59. That is, the closing plate is suspended by the pressing roller 59 due to the weight of the closing plate. Thus, as the pressing roller 59 moves upward, the guide hole 58 in the blowing passage 62 can be closed by the closing plate.

Differently from the third embodiment, another guide hole 58, another pressing roller 59 and another winding roller 61 may also be provided at the upstream side (left side) of the blowing passage 62, so that the sectional area of the blowing passage 62 at the upstream side (left side) can be changed similarly to the downstream side (right side). For example, both ends of the film 60 may be wound around the two winding rollers 61 at the upstream side and the downstream side, and the film 60 may be wound around the two pressing rollers 59 which are guided along the guide holes 58 which are spaced apart from each other in the right and left directions by a predetermined interval. Thus, the whole sectional area of the blowing passage 62 can be arbitrarily changed.

Differently from the previous embodiments, the widths L4 of the drying units 36a, 36b, 51 and 57 may not coincide with the widths L1 of the nozzle arrays 21 in the unit heads 18a and 18b. For example, a plurality of the first drying units 36a, which have widths smaller than the width L1 of the nozzle array 21, may be configured to be adjacent to each other in the front and rear directions, so that widths L4 of the first drying units 36a may coincide with the width L1 of the nozzle array 21.

Differently from the previous embodiments, the hot wind unit 35 may include a plurality of drying units which are adjacent to each other in the transport direction (right and left directions). For example, it is possible to install driving units, which are installed in the front and rear directions and have a rectangular shape when viewed in a plan view, and upstream driving units which are adjacent to the driving units at the left side and which correspond to the first unit heads 18a in the right and left directions. In addition, it is possible to install downstream driving units which are adjacent to the driving units at the right side and which correspond to the second unit heads 18b in the right and left directions.

According to the previous embodiments, the unit heads 18a and 18b are arranged in two rows in the right and left directions. However, the unit heads 18a and 18b may be arranged in three rows or more. Further, the unit heads 18a and 18b may be slantingly arranged one by one such that the unit heads 18a and 18b are deviated from each other in the right and left directions and the width direction. In such a case, the driving units 36a, 36b, 51 and 57 have the arrangement identical to the arrangement of the unit heads 18a and 18b. That is, the driving units 36a, 36b, 51 and 57 may be arranged such that the distance between each of the driving units 36a, 36b, 51 and 57 and the corresponding unit head 18a or 18b is constant.

According to the previous embodiments, the hot wind is employed as the heating device that drives the ink attached to the sheet 12. However, a heater capable of heating the sheet 12 may be employed as the heating device. For example, a heater, which is bent to extend in the left direction at a first position corresponding to the first unit head 18a in the right and left directions and is bent in the right direction at a second position corresponding to the second unit head 18b in the right and left directions as compared with the first position, may be installed in the support plate 25. Thus, heat from the heater, which is bent to extend in the left direction, is applied to the primary attachment area A from the upstream side (left side) of the transport direction (right and left directions), so that drying of the primary attachment area A is prompted. Further, the heat of the heater, which is bent to extend in the right direction, is applied to the secondary attachment area B at the timing different from the timing at which the heat is applied to the primary attachment area A, so that drying of the secondary attachment area B is prompted. Therefore, the difference between the time at which the primary attachment area A is heated and the time at which the secondary attachment area B is heated after the ink is attached to the sheet 12 is reduced, so that uneven drying can be prevented from occurring.

According to the previous embodiments, the printer 11 uses the line head type recording head 19 in which the unit heads 18a and 18b are arranged in the front and rear directions. However, it is possible to employ a lateral printer that performs printing by intermittently transporting the sheet 12 and moving the recording head 19 in the right and left directions and the width direction. That is, the hot wind unit 35 can be applied to a printer in which the difference occurs in attachment timing of ink in the width direction perpendicular to the transport direction of the sheet 12. For example, in a case in which ink is ejected toward the sheet 12 during movement in the right and left directions, position deviation is obtained in the front side, and then the ink ejection is repeated after movement in the right and left directions, the width of the driving unit is identical to an ejection area of the ink due to the movement in the right and left directions. Further, the driving unit located at the rearmost side may be disposed at the uppermost side and the remaining driving units may be sequentially disposed at the downstream side toward the front side. In this way, the time difference until the drying process is performed after the ink is attached to the sheet 12 can be reduced in each area of the sheet 12.

According to the previous embodiments, the recording apparatus is embodied as the ink jet printer 11. However, a liquid ejection apparatus for ejecting or exhausting liquid other than ink may be employed. The recording apparatus is available for various liquid ejection apparatuses provided with a liquid ejection head that exhausts a small amount of liquid droplets. For example, the liquid droplets are in a liquid state, which are exhausted from the liquid ejection apparatus, and may include a grain shape with a long tail, teardrops with a long tail, and a thread shape with a long tail. Further, the liquid may include various materials which can be ejected from the liquid ejection apparatus. For example, the liquid may denote materials in a liquid phase, and may include liquid-phase materials having high or low viscosity, sol, gel water, and materials in a flowing state such as inorganic solvents, organic solvents, solutions, liquid phase resin and liquid phase materials (metal melt). Further, the liquid may include materials, which are obtained through dissolution, dispersion or mixing between particles of functional materials including solid materials (e.g., pigments or metal particles) and solvent, as well as liquid as one state of material. Further, the ink as described in the previous embodiments, liquid crystal or the like is a representative example of the liquid. The ink may include various liquid compositions such as normal water-based ink, solvent-based ink, gel ink and hot melt ink. For example, the liquid ejection apparatus may include a liquid ejection apparatus that ejects liquid including dispersed or dissolved electrode materials or color materials, which are used for manufacturing a liquid crystal display, an EL (electroluminescence) display, a surface emitting display, a color filter and the like, a liquid ejection apparatus that ejects bio-organic materials used for manufacturing a bio chip, a liquid ejection apparatus used as a precise pipette to eject liquid, a dyeing apparatus, a micro-dispenser and the like. In addition, it is possible to employ a liquid ejection apparatus that ejects lubricating oil to a precision apparatus such as a watch or a camera through a pin point, a liquid ejection apparatus that ejects transparent resin solution, such as UV curing resin, onto a substrate to form a micro hemispheric lens (optical lens) used for a light communication device and the like, and a liquid ejection apparatus that ejects etchant such as acid or alkali to etch a substrate. Further, the invention can be applied to at least one of the liquid ejection apparatuses.

What is claimed is:

1. A recording apparatus comprising:
a transport unit that transports a target from an upstream side of a transport direction to a downstream side of the transport direction;
a recording unit having a configuration in which at least one of a plurality of unit heads is deviated from another unit head in the transport direction, and performing a recording operation by attaching liquid to a target by each unit head, the unit heads allowing liquid ejecting nozzles to form nozzle arrays in a width direction of the target perpendicular to the transport direction; and
a plurality of drying units having an arrangement identical to an arrangement of the unit heads in the transport direction and the width direction at a downstream side of the transport direction as compared with the recording unit, and drying the target.

2. The recording apparatus according to claim 1, wherein each drying unit has a widthwise size, which is identical to a widthwise size of the nozzle arrays formed in each unit head.

3. The recording apparatus according to claim 1, wherein the drying unit is provided with a blowing passage formation member which has a blowing path extending in the transport direction and is formed with a blowing port that extends in the transport direction to blow air toward the target in the blowing path while facing the target, the blowing path having a sectional area at the upstream side of the transport direction, which is larger than a sectional area at the downstream side of the transport direction.

4. The recording apparatus according to claim 1, wherein the drying unit is provided with a blowing passage formation member and a sectional area change unit, the blowing passage formation member having a blowing path extending in the transport direction and being formed with a blowing port that extends in the transport direction to blow air toward the target in the blowing path while facing the target, the blowing path having a sectional area at the upstream side of the transport direction, which is larger than a sectional area at the downstream side of the transport direction, the sectional area change unit changing a sectional area of the blowing path in the blowing passage formation member by moving a wall surface of the blowing path.

5. A method for drying a target, the method comprising:
performing a first recording process of attaching liquid to a target at a first timing;
performing a second recording process of attaching the liquid to a position of the target, which is different from a liquid attachment position in the first recording process, at a second timing different from the first timing;
performing a first drying process of drying the liquid attached to the target in the first recording process; and
performing a second drying process of drying the liquid, which is attached to the target in the second recording process, with a time difference between the first timing and the second timing.
